(19) United States
(12) Patent Application Publication
(10) Pub. No.: US 2025/0324504 A1
(43) Pub. Date: Oct. 16, 2025

(54) SYSTEMS AND METHODS FOR PRODUCING ULTRA-HIGH DC VOLTAGES IN OPEN FIELD LINE TRAPS WITH MINIMAL DISSIPATION AND MINIMAL DAMAGE

(71) Applicant: The Trustees of Princeton University, Princeton, NJ (US)

(72) Inventors: Nathaniel J. Fisch, Princeton, NJ (US); Elijah Kolmes, Plainsboro, NJ (US); Mikhail Mlodik, Princeton, NJ (US); Ian Ochs, New York, NY (US); Jean Marcel Rax, Princeton, NJ (US); Tal Rubin, Princeton, NJ (US)

(73) Assignee: The Trustees of Princeton University, Princeton, NJ (US)

(21) Appl. No.: 19/175,473

(22) Filed: Apr. 10, 2025

Related U.S. Application Data
(60) Provisional application No. 63/632,068, filed on Apr. 10, 2024.

(51) Int. Cl. H05H 1/04; H05H 1/16

(52) U.S. Cl. CPC H05H 1/04; H05H 1/16

(57) ABSTRACT

A method may be provided for producing a voltage across a magnetized plasma. The techniques may include generating, within a plasma device having at least one outer boundary that defines walls, at least one magnetic field including an axially directed magnetic field in an open field line configuration. The axial-directed magnetic field may confine a plasma in a direction perpendicular to the magnetic field. The techniques may also include generating at least one electric field within the plasma device.

### CROSS-REFERENCE TO RELATED APPLICATIONS

The present application claims priority to U.S. Provisional Application No. 63/632,068 filed Apr. 10, 2024, the entirety of which is incorporated by reference herein.

### STATEMENT REGARDING FEDERALLY SPONSORED RESEARCH OR DEVELOPMENT

This invention was made with government support under Grant No. DE-AR0001554 awarded by the Department of Energy's Advanced Research Projects Agency-Energy (ARPA-E). The government has certain rights in the invention.

### TECHNICAL FIELD

The present disclosure is drawn to systems and methods for producing ultra-high DC voltages in open field line traps with minimal dissipation and minimal damage.

### BACKGROUND

This section is intended to introduce the reader to various aspects of the art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Hot plasma is highly conductive in the direction parallel to a magnetic field. This often means that the electrical potential will be nearly constant along any given field line. When this is the case, the cross-field voltage drops in open-field line magnetic confinement devices are limited by the tolerances of the solid materials wherever the field lines impinge on the plasma-facing components. Overcoming this limitation may include producing large voltage drops in the interior of a magnetic confinement device, while coexisting with much smaller drops on the boundaries.

### BRIEF SUMMARY

Various deficiencies in the prior art are addressed below by the disclosed systems and methods for producing ultra-high DC voltages in open field line traps with minimal dissipation and minimal damage.

In various aspects, a method for producing a voltage across a magnetized plasma may be provided. The method may include generating, within a plasma device having at least one outer boundary that defines walls, at least one magnetic field including an axially directed magnetic field in an open field line configuration. The axially directed magnetic field may confine a plasma in a direction perpendicular to the magnetic field. The method may also include generating at least one electric field within the plasma device.

In some embodiments the at least one electric field may have a component parallel to magnetic field lines such that the at least one electric field is larger in an interior region of the plasma and substantially reduced near the walls of the plasma device.

In some embodiments, the method may further include reducing electric field strength near the walls by increasing resistivity of the plasma. The method may further include introducing a cold plasma between the walls and the plasma. In some embodiments, the method may further include introducing radiating impurities into the cold plasma.

In some embodiments, the method may include modifying a geometry of the magnetic field lines such that the magnetic field lines spread before contacting the walls so as to reduce the electric field for a given voltage drop. The method may further include modifying an angle of contact between the magnetic field lines and the walls so as to reduce the electric field for a given voltage drop.

In some embodiments, the at least one electric field and at least one magnetic field may be configured to substantially mitigate natural dissipation of the electric field.

In some embodiments, the at least one magnetic field may be configured to have a plurality of magnetic field lines shaped into conducting wall regions which act as electrodes separated by insulators. The walls may include a first wall. The first wall may be configured with first conducting regions having insulating gaps. The walls may also include a second wall. The second wall may be configured with second conducting regions having insulating gaps, such that magnetic field lines of the axially directed magnetic field first encounter the first conducting regions or the second conducting regions.

In some embodiments, the method may further include isolating a radial voltage drop in an interior of the plasma so an electric field at the wall is smaller than an electric field in the interior of the plasma by setting field strength and shape of the at least one magnetic field so as to use centrifugal forces to modify plasma currents in a direction parallel to the magnetic field.

In some embodiments, the method may further include generating at least a part of a voltage drop using wave-particle interactions so as to avoid or reduce reliance on contact with external electrodes.

In some embodiments, the method may further include generating at least a part of a voltage drop using torque from neutral beams.

In some embodiments, the at least one magnetic field may include a diverging nozzle geometry.

In various aspects, a system may be provided. The system may include a magnetic field source. The magnetic field source may be configured to generate at least one magnetic field including an axially directed magnetic field in an open field line configuration. The axially directed magnetic field may be configured to confine a plasma in a direction perpendicular to the magnetic field. The system may also include an electric field source. The electric field source may be configured to generate a steady-state electric field parallel to magnetic field lines produced by the magnetic field source such that the steady-state electric field is larger in an interior region of the plasma and substantially reduced in boundary regions of the plasma.

### BRIEF DESCRIPTION OF FIGURES

The accompanying drawings, which are incorporated in and constitute a part of this specification, illustrate embodiments of the present disclosure and, together with a general description of the present disclosure given above, and the detailed description of the embodiments given below, serve to explain the principles of the present disclosure.

FIG. 1 shows a flow diagram of a method for producing a voltage across a magnetized plasma according to the various embodiments.

FIG. 2 shows a graphical representation of closed isopotential surfaces.

FIGS. 3A-B show a graphical representation of a low-dissipation solution for the distribution of electrostatic potential and electric field.

FIG. 4 shows a geometric strategy for reducing edge electric fields according to the various embodiments.

It should be understood that the appended drawings are not necessarily to scale, presenting a somewhat simplified representation of various features illustrative of the basic principles of the present disclosure. The specific design features of the sequence of operation as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following drawings merely illustrate the principles of the present disclosure. It will thus be appreciated that those skilled in the art will be able to devise various arrangements that, although not explicitly described or shown herein, embody the principles of the present disclosure and are included within its scope. Furthermore, all examples recited herein are principally intended expressly to be only for illustrative purposes to aid the reader in understanding the principles of the present disclosure and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the claims. Moreover, some statements may apply to some features but not to others. Those skilled in the art and informed by the teachings herein will realize that the present disclosure is also applicable to various other technical areas or embodiments.

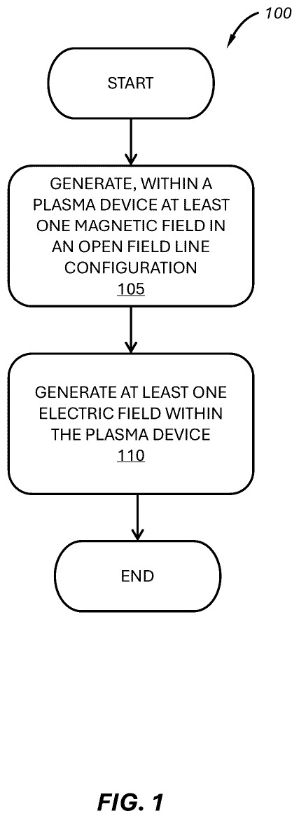

Referring to FIG. 1, an embodiment of a method for producing a voltage across a magnetized plasma is shown. The method (100) may include generating (105), within a plasma device having at least one outer boundary that defines walls, at least one magnetic field including an axially directed magnetic field in an open field line configuration. The axially directed magnetic field may confine a plasma in a direction perpendicular to the magnetic field lines.

Still referring to FIG. 1, the method may also include generating (110) at least one electric field within the plasma device. The at least one electric field may have a component parallel to magnetic field lines such that the at least one electric field is larger in an interior region of the plasma and substantially reduced near the walls of the plasma device.

In some embodiments, the method may further include reducing electric field strength near the walls by increasing resistivity of the plasma. The method may further include introducing a cold plasma between the walls and the plasma. In some embodiments, the method may further include introducing radiating impurities into the cold plasma.

In some embodiments, the method may include modifying a geometry of the magnetic field lines such that the magnetic field lines spread before contacting the walls so as to reduce the electric field for a given voltage drop. The method may further include modifying an angle of contact between the magnetic field lines and the walls so as to reduce the electric field for a given voltage drop.

In some embodiments, the angle may be modified by at least 10 degrees. In some embodiments, the angle may be modified by at least 15 degrees. In some embodiments, the angle may be modified by at least 20 degrees. In some embodiments, the angle may be modified by at least 25 degrees. In some embodiments, the angle may be modified by at least 30 degrees. In some embodiments, the angle may be modified by at least 35 degrees. In some embodiments, the angle may be modified by at least 40 degrees. In some embodiments, the angle may be modified by at least 45 degrees.

In some embodiments, the at least one electric field and at least one magnetic field may be configured to substantially mitigate natural dissipation of the electric field.

In some embodiments, the at least one magnetic field may be configured to have a plurality of magnetic field lines shaped into conducting wall regions which act as electrodes separated by insulators. The walls may include a first wall. The first wall may be configured with first conducting regions having insulating gaps. The walls may also include a second wall. The second wall may be configured with second conducting regions having insulating gaps, such that magnetic field lines of the axially directed magnetic field first encounter the first conducting regions or the second conducting regions.

In some embodiments, the method may further include isolating a radial voltage drop in an interior of the plasma so an electric field at the wall is smaller than an electric field in the interior of the plasma by setting field strength and shape of the at least one magnetic field so as to use centrifugal forces to modify plasma currents in a direction parallel to the magnetic field.

In some embodiments, the method may further include generating at least a part of a voltage drop using wave-particle interactions so as to avoid or reduce reliance on contact with external electrodes.

In some embodiments, the method may further include generating at least a part of a voltage drop using torque from neutral beams.

In some embodiments, the at least one magnetic field may include a diverging nozzle geometry.

In various aspects, a system may be provided. The system may include a magnetic field source. The magnetic field source may be configured to generate at least one magnetic field including an axially directed magnetic field in an open field line configuration. The axially directed magnetic field may be configured to confine a plasma in a direction perpendicular to the magnetic field. The system may also include an electric field source. The electric field source may be configured to generate a steady-state electric field parallel to magnetic field lines produced by the magnetic field source such that the steady-state electric field is larger in an interior region of the plasma and substantially reduced in boundary regions of the plasma.

The following examples serve to illustrate the principles of the present disclosure. The examples are provided to aid the reader in understanding the various techniques outlined herein. Those skilled in the art and informed by the teachings herein will realize some statements may apply to some features but not to others.

### Example 1

Hot plasma is highly conductive in the direction parallel to a magnetic field. This often means that the electrical potential will be nearly constant along any given field line. When this is the case, the cross-field voltage drops in open-field-line magnetic confinement devices are limited by the tolerances of the solid materials wherever the field lines impinge on the plasma-facing components. To circumvent this voltage limitation, one may arrange large voltage drops in the interior of a device but coexisting with much smaller drops on the boundaries. To avoid prohibitively large dissipation requires both preventing substantial drift-flow shear within flux surfaces and preventing large parallel electric fields from driving large parallel currents. It is demonstrated here that both requirements can be met simultaneously, which opens up the possibility for magnetized plasma tolerating steady-state voltage drops far larger than what might be tolerated in material media.

The largest steady-state laboratory electrostatic potential in the world was likely produced by the Van de Graaf-like pelletron generator at the Holifield facility at Oak Ridge National Laboratory. Housed within a 30-meter-tall, 10-meter-diameter pressure chamber filled with insulating SF₆ gas, the generator was able to maintain electrostatic potentials of around 25 MV. The main obstacle limiting the production of even greater potentials in the laboratory is the breakdown electric field of the surrounding medium.

A fully ionized plasma is a promising setting in which to pursue very large voltage drops, in part because it is by definition already broken down. Moreover, once a magnetic field is added, plasma has a very attractive property: charged particles cannot move across the magnetic field lines, as they are confined on helical paths along the field. As long as a stable plasma equilibrium is identified, the particles can only move across the field as a result of collisions and cross-field drifts and thus are theoretically capable of coexisting with much larger electric fields than could a gas.

Unfortunately, this nice confinement property only works along two out of three of the spatial dimensions with electrons free to stream along magnetic field lines, shorting out any “parallel” electric field. For instance, in a cylinder with the magnetic field pointing along the axis, the medium is highly insulating along the radial and azimuthal directions, but highly conductive along the axial direction. Thus, one must either loop the fields around on themselves, which introduces a variety of instabilities and practical difficulties, or one must introduce a potential drop along the field lines.

This latter approach is closely related to a magnetic confinement concept known as the centrifugal mirror trap, which has applications both in nuclear fusion and mass separation. These devices typically consist of an approximately radial electric field superimposed on an approximately axial magnetic field, such that the resulting E×B drifts produce azimuthal rotation. By pinching the ends of the device to smaller radius, particles must climb a centrifugal potential in order to exit the device and thus can be confined. The conventional strategy for imposing the desired electric field is to place nested ring electrodes at the ends of the device, relying on the high parallel conductivity to propagate the potential into the core. However, this strategy fundamentally limits the achievable core electric field, and thus the achievable centrifugal potential, since one must avoid arcing across the end electrodes. The question of confining the electric potential to the center of the device is thus not only of academic interest, but also of significant practical interest in such centrifugal concepts.

In the present disclosure, an arrangement in which the voltage drop is produced in the interior of the plasma using either wave-particle interactions or neutral beams is proposed. Wave-particle interactions have been proposed to move ions across field lines for the purpose of achieving the alpha channeling effect, where the main purpose is to remove ions while extracting their energy. Here the focus is instead on moving net charge across field lines. Moving charge across field lines could sustain a potential difference in the interior of the system that is higher than the potential across the plasma-facing material components at the ends.

In order for wave-driven electric fields to entirely circumvent the most important material restrictions on electrode-based systems, it is necessary that the voltage drop not only be driven in the interior of the plasma but that it be contained there. Otherwise, the induced voltage drops will simply incur power dissipation at the plasma boundaries no matter where along the magnetic surface the voltage drop is induced. In other words, there must be steady-state electric fields parallel to the magnetic field lines.

Relatively small parallel electric fields have long been predicted (and observed) in mirror-like configurations. Larger fields have been predicted and observed for some systems but have typically not been achievable in higher-temperature steady-state laboratory systems, for two very good reasons. First: if the flux surfaces are not close to being isopotential surfaces, then the rotations may be strongly sheared along a given flux surface. This would tend to lead to significant dissipation, and perhaps also to twisting-up of the magnetic field as the sheared plasma carries the field lines along with it. Second: large parallel fields typically incur large Joule heating. The resulting dissipation from either of these effects could be prohibitively large for many applications.

Eliminating the large dissipation terms while maintaining a large parallel component of E requires revisiting conventional assumptions about isorotation, i.e., the conditions under which the plasma on each flux surface will rotate with a fixed angular velocity. While the absence of parallel electric fields is a sufficient condition for isorotation—this is Ferraro's isorotation law—it is not a necessary condition. Moreover, there are cases in which large parallel fields can exist with vanishingly small parallel currents. In principle, then, it is possible to construct extremely low-dissipation systems with both (1) a very large voltage drop across the field lines in the interior of the plasma and (2) little or no voltage drop across the field lines at the edges of the plasma. Of course, being possible is not the same as being easy, and meeting all of these conditions simultaneously puts stringent conditions on the system.

However, if a contained voltage drop were attainable the resulting possibilities could be striking. Fast rotation is desirable for fusion technologies and mass filtration; moreover, the possibility of achieving ultra-high DC voltage drops in the laboratory—and, particularly, of decoupling the achievable voltages from the constraints associated with material properties of solids—could be even more broadly useful.

The necessary and sufficient conditions for isorotation in an axisymmetric plasma is discussed herein. The usual isorotation picture, in which each flux surface is a surface of constant voltage, is one special case of these conditions.

Consider an axisymmetric plasma—that is, in (r, θ, z) cylindrical coordinates, suppose that the system is symmetric with respect to θ. Suppose there is no θ-directed magnetic field. Define the flux ψ by:

$$ψ \dot{=} {\int }_{0}^{r} {r}^{′} {B}_{z} ( {r}^{′} , z ) {dr}^{′} . \qquad ( 1 )$$

This definition, combined with the requirement that ∇·B=0, implies that

$$B = - \frac{1}{r} \frac{ψ}{\partial z} \hat{r} + \frac{1}{r} \frac{\partial ψ}{\partial r} \hat{z} = ∇ ψ \times ∇ θ . \qquad ( 2 )$$

If the current j satisfies j·∇ψ=0, it is possible to find a third coordinate χ and scalar function γ such that

$$B = ∇ χ + γ ∇ ψ \qquad ( 3 )$$

Equations. (2) and (3) imply that

$$∇ χ \cdot ( ∇ ψ \times ∇ θ ) = {B}^{2} . \qquad ( 4 )$$

In the low-β (vacuum-field) limit, we can take γ→0 and χ to be the magnetic scalar potential. This is possible because, in the absence of plasma currents, the curl of B vanishes everywhere in the interior of the plasma and the Helmholtz decomposition can be written in terms of a pure scalar potential.

Suppose the electric field E is given by E=−∇ϕ. Then the E×B drift is given by

$${v}_{E \times B} = - \frac{∇ ϕ \times B}{{B}^{2}} \qquad ( 5 )$$

$$= - \frac{1}{{B}^{2}} ( \frac{\partial ϕ}{\partial ψ} - γ \frac{\partial ϕ}{\partial χ} ) ∇ ψ \times ∇ χ \qquad ( 6 )$$

And the E×B rotation frequency is

$${Ω}_{E} = {v}_{E \times B} \cdot ∇ θ = \frac{\partial ϕ}{\partial ψ} - γ \frac{\partial ϕ}{\partial χ} . \qquad ( 7 )$$

Then, assuming a nonvanishing field,

$$B \cdot ∇ {Ω}_{E} = 0 iff . \frac{\partial }{\partial χ} ( \frac{\partial ϕ}{\partial ψ} - γ \frac{\partial ϕ}{\partial χ} ) = 0. \qquad ( 8 )$$

Eq. (8) is satisfied by any potential of the form ϕ=ϕ_{∥}+ϕ_{⊥}(ψ), where B·∇ϕ_{⊥}0 and B×∇ϕ_{∥}=0. In the low-case, the situation is particularly simple: B·∇Ω_{E} vanishes if and only if

$$ϕ = {ϕ}_{‖} ( χ ) + {ϕ}_{⊥} ( ψ ) \qquad ( 9 )$$

For arbitrary functions ϕ_{∥} and ϕ_{⊥}. These two potentials will correspond to electric fields in the parallel and perpendicular directions, respectively. The entire system will rotate as a solid body if, in addition, ϕ_{⊥} is a linear function of ψ.

For some systems, the diamagnetic drift velocities may not be negligible compared with the E×B velocity. In that case, the viscous dissipation typically depends on shear in the combined drift velocity. At least in the isothermal case, the generalization of Eq. (9) is straightforward. Define the effective (electrochemical) potential φₛ for species s defined by

$${φ}_{s} \dot{=} ϕ - \frac{{T}_{s}}{{q}_{s}} log {n}_{s} , \qquad ( 10 )$$

where nₛ, Tₛ, and qₛ, are the density, temperature, and charge of species s. This object is sometimes known as the “thermal” or “thermalized” potential in the Hall thruster literature. In terms of φₛ, the combined rotation frequency is

$${Ω}_{s , tot} = \frac{\partial {φ}_{s}}{\partial ψ} - γ \frac{\partial {φ}_{s}}{\partial χ} , \qquad ( 11 )$$

$$with$$

$$B \cdot ∇ {Ω}_{s , t o t} = 0 iff . \frac{\partial }{\partial χ} ( \frac{\partial {φ}_{s}}{\partial ψ} - γ \frac{\partial {φ}_{s}}{\partial χ} ) = 0 \qquad ( 12 )$$

reducing to the requirement that

$${φ}_{s} = {ϕ}_{s , ‖} ( χ ) + {φ}_{s , ⊥} ( ψ ) \qquad ( 13 )$$

in the vacuum-field limit.

The classical form of the isorotation theorem takes the electrostatic potential to be a flux function: that is, ϕ=ϕ(ψ). The extension to a generalized potential—that is, φₛ=φₛ(ψ)—has been known for some time in the literature on plasma propulsion. These previous cases provide sufficient conditions for isorotation. The more generalized expression derived here is the necessary and sufficient conditions for isorotation.

In cases with very fast rotation—that is, with Ω_{s,tot} comparable to the particle's gyrofrequency-additional inertial effects can become relevant. The centrifugal F×B drift can be incorporated by including an appropriate term in the electrochemical potential; in cases where the centrifugal force mₛrΩ_{s,tot}²\hat{r} is the gradient of a centrifugal potential, this is as simple as adding that potential to φₛ. In the vacuum-field limit, the effective perpendicular potential

$${φ}_{c s , e f f} = - {\int }_{0}^{ψ} \frac{{m}_{s} {Ω}_{s , tot}^{2} ( χ , {ψ}^{′} ) {B}_{z} ( χ , {ψ}^{′} ) d {ψ}^{′}}{{q}_{s} {B}^{2} ( χ , {ψ}^{′} )} , \qquad ( 14 )$$

Leads to the appropriate drift frequency ∂φ_{cs,eff}/∂ψ, whether or not the centrifugal force has a curl. However, note that once Ω_{s,tot} is comparable to the gyrofrequency, excursions of the particle trajectories from the flux surfaces can also become significant.

### Example 1A

Consider a magnetic field given by B=∇χ where

$$χ = {B}_{0} L [ \frac{Z}{L} - \frac{α}{2 π} sin ( \frac{2 π z}{L} ) {I}_{0} ( \frac{2 π r}{L} ) ] \qquad ( 15 )$$

Here I₀ denotes a modified Bessel function of the first kind. This scalar potential leads to

$${B}_{z} = {B}_{0} L [ 1 - α cos ( \frac{2 π z}{L} ) {I}_{0} ( \frac{2 π r}{L} ) ] \qquad ( 16 )$$

$$and$$

$${B}_{r} = - {B}_{0} α sin ( \frac{2 π z}{L} ) {I}_{1} ( \frac{2 π r}{L} ) . \qquad ( 17 )$$

Then the flux function can be written as

$$ψ = \frac{{B}_{0} {r}^{2}}{2} [ 1 - \frac{α L}{π r} cos ( \frac{2 π z}{L} ) {I}_{1} ( \frac{2 π r}{L} ) ] \qquad ( 18 )$$

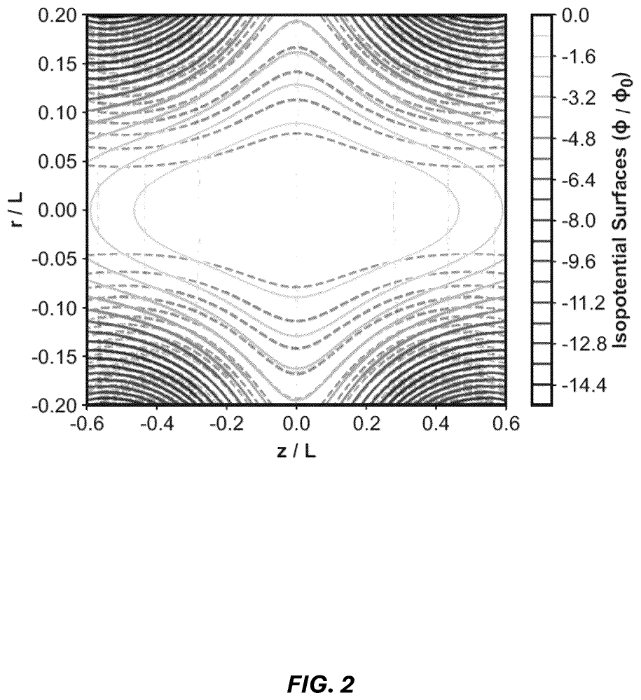

Having an explicit form for χ and ψ makes it straightforward to construct an example in which the isopotential surfaces close and B·∇Ω_{E} vanishes. FIG. 2 shows one such example, with

$$\frac{ϕ}{{ϕ}_{0}} = - \frac{ψ ( r , z )}{ψ ( L / 10 , 0 )} - {( \frac{χ ( r , z )}{χ ( 0 , L / 2 )} )}^{2} . \qquad ( 19 )$$

More specifically, the curves shown in FIG. 1 depict isopotential surfaces for the example potential discussed in Example 1A solution, such that the E×B rotation frequency does not vary along field lines. The horizontally- and vertically-oriented curves trace out the level contours for ψ and χ, respectively.

### Parallel Currents

The potential structure shown in FIG. 2 avoids parallel shear in Ω_{E}. However, large parallel electric fields are likely to lead to large parallel currents. It might be possible to maintain such fields with means of noninductive current drive, but for small power dissipation the noninductive current drive must be efficient, whereas the return current must encounter high plasma resistivity, which is unlikely in the hot plasmas considered here which would have large parallel conductivity.

In order to understand the behavior of these parallel currents, consider a simple two-fluid model for steady-state operation of a single-ion species plasma, possibly with some external forcing [symbol] ᵢₑ and inertial forces [symbol] _{ci∥}:

$$- {n}_{i} {F}_{ci ‖} = {Zen}_{i} \cdot {E}_{‖} - {∇}_{‖} {p}_{i} + {m}_{i} {n}_{i} {v}_{i e} ( {v}_{e ‖} - {v}_{i ‖} ) + {n}_{i {ℱ}_{i}} \qquad ( 20 )$$

$$and$$

$$0 = - e {n}_{e} {E}_{‖} - {∇}_{‖} {p}_{e} + {m}_{e} {n}_{e} {ν}_{e i} ( {v}_{i ‖} - {v}_{e ‖} ) + {n}_{e {ℱ}_{i}} \qquad ( 21 )$$

Here Z is the ion charge state, e is the elementary charge pₛ is the pressure of species s, mₛ is the mass of species s, and ν_{ss′} is the momentum transfer frequency for species s and s′. The parallel subscript denotes the component parallel to B—for example, E_{∥}=E·B/B. Suppose Tᵢ and Tₑ are constant and nₑ=Znᵢ.

$$Define$$

$${ξ}_{+} \dot{=} {n}_{i {ℱ}_{i}} + {n}_{e {ℱ}_{e}} \qquad ( 22 )$$

$${ξ}_{-} \dot{=} {n}_{i {ℱ}_{i}} + {n}_{e {ℱ}_{e}} \qquad ( 23 )$$

$$Then$$

$${∇}_{‖} ( {p}_{i} + {p}_{e} ) = {n}_{i} {F}_{ci ‖} + {ξ}_{+} \qquad ( 24 )$$

$$and$$

$$η {j}_{‖} = {E}_{‖} + \frac{- {∇}_{‖} ( {p}_{i} - {p}_{e} ) + {n}_{i} {F}_{ci ‖} + {ξ}_{-}}{2 Z e {n}_{i}} \qquad ( 25 )$$

Here ηmₑνₑᵢ/e²nₑ. Eq. (24) can be rewritten as

$$η {j}_{‖} = {E}_{‖} + \frac{{T}_{e}}{Z {T}_{e} + {T}_{i}} \frac{{F}_{ci ‖}}{e} + \frac{1}{2 e {n}_{e}} ( \frac{Z {T}_{e} - {T}_{i}}{Z {T}_{e} + {T}_{i}} {ξ}_{+} + {ξ}_{-} ) . \qquad ( 26 )$$

In the absence of momentum injection, ξ₊=ξ₋=0, and the current is proportional to the deviation of the electric field from its “natural” ambipolar value. The same effect appears in the case with more than one ion species. However, it is analytically much more complicated to describe due to the proliferation of additional simultaneous equations as more species are included.

Eq. (26) suggests that there are two strategies with which it might be possible to maintain a parallel electric field. The first is to use external forcing (noninductive current drive) to maintain some E_{∥}. The first allows for a wider range of outcomes, but the second avoids the problem of very large energy costs when η is small.

There is neither j_{∥}E_{∥} Ohmic dissipation nor any need for external forcing when

$$ϕ ( χ , ψ ) - ϕ ( 0 , ψ ) = \frac{{T}_{e}}{Z {T}_{e} + {T}_{i}} \frac{{m}_{i}}{2 e} [ {{Ω}_{E} ( χ , ψ )}^{2} {r}^{2} - {{Ω}_{E} ( 0 , ψ )}^{2} {r}_{0}^{2} ] , \qquad ( 27 )$$

where r₀ is the value of r when χ=0 for a given flux surface ψ. This follows from integrating Eq. (26). Expressions closely related to Eq. (27) have long been known in the literature; this parallel variation in ϕ is sometimes called the ambipolar potential. Eq. (27) can be written equivalently as

$${{ϕ ( χ , ψ ) - ϕ ( 0 , ψ ) = \frac{{T}_{e}}{Z {T}_{e} + {T}_{i}} \frac{{m}_{i}}{2 e} [ {( \frac{\partial ϕ}{\partial ψ} - γ \frac{\partial ϕ}{\partial χ} )}^{2} \vert}_{( χ , ψ )} {r}^{2} - {( \frac{\partial ϕ}{\partial ψ} - γ \frac{\partial ϕ}{\partial χ} )}^{2} \vert}_{( 0 , ψ )} {r}_{0}^{2} ] . \qquad ( 28 )$$

There are a few things to point out about Eq. (28). First: this condition can also be derived by enforcing that the electrons and ions are both Gibbs-distributed along field lines (though not necessarily across field lines). This makes sense; if the distributions are Gibbs-distributed in the parallel direction, then one should expect parallel currents to vanish. Second: if species sis Gibbs-distributed along field lines (and if the plasma is isothermal) then we also have that ϕₛ=ϕ_{s,⊥}(ψ); the electrochemical potential is a flux function, and each flux surface will isorotate. This means that potentials satisfying Eq. (28) avoid not only the dissipation associated with parallel currents but also the dissipation associated with shear along flux surfaces. Note, however, that in cases where the centrifugal force is not the gradient of a potential, the ions may not have a well-defined Gibbs distribution. In these cases, j_{∥}=0 leads to isorotation of the electrons, but the ions may still have some shear. However, this shear is suppressed when either (1) the rotation frequency is small compared with the ion gyrofrequency or (2) the centrifugal force is close to being the gradient of a scalar function.

### Challenges

Solutions to Eq. (28) have desirable properties, but they come with significant challenges if they are to lead to closed isopotential surfaces. The first of these has to do with the magnitude of the variation of φ in the parallel and perpendicular directions. It is clearest to see in the case where φ can be decomposed so that φ=φ_{∥}(χ)+ϕ_{⊥}(ψ) and where B is a vacuum field. In this case, Eq. (28) becomes

$$∇ {ϕ}_{‖} = - \frac{{T}_{e}}{Z {T}_{e} + {T}_{i}} \frac{{m}_{i}}{2 e} {Ω}_{E}^{2} ( {r}_{0}^{2} - {r}^{2} ) , \qquad ( 29 )$$

where ∇ϕ_{∥}ϕ_{∥}(χ)−ϕ_{∥}(0). If E_{⊥}=−∇ϕ_{⊥}/L_{⊥} for some perpendicular length scale L_{⊥}, then this can be rewritten as

$$\frac{∇ {ϕ}_{\vert \vert}}{∇ {ϕ}_{⊥}} = \frac{1}{2} ( \frac{Z {T}_{e}}{Z {T}_{e} + {T}_{i}} ) \frac{{Ω}_{E}}{{Ω}_{c i}} \frac{{r}_{0}^{2} - {r}^{2}}{r {L}_{⊥}} . \qquad ( 30 )$$

Here Ω_{ci}ZeB/mᵢ and Ω_{E} is taken as Ω_{E}=∇ϕ_{⊥}/rL_{⊥}B. The Brillouin limit requires that Ω_{E}/Ω_{ci}<¼; beyond this limit (which does depend on the sign of the electromagnetic fields), the plasma cannot be confined. Then, assuming E_{⊥}>0, ∇ϕ_{∥}=ϕ_{⊥} is only realizable if

$${L}_{⊥} < \frac{1}{8} \frac{{r}_{0}^{2} - {r}^{2}}{r} . \qquad ( 31 )$$

This suggests that in a cylindrically symmetric system, the plasma must occupy only a thin annular region (such that the perpendicular length scale can be small compared with the radius).

This constraint can be seen from a different perspective by rewriting Eq. (30) as

$$\frac{∇ {ϕ}_{\vert \vert}}{∇ {ϕ}_{⊥}} = \frac{1}{2} ( \frac{Z {T}_{e}}{Z {T}_{e} + {T}_{i}} ) {Ma}_{0} \frac{{ρ}_{L i}}{{L}_{⊥}} \frac{{r}_{0}^{2} - {r}^{2}}{r {r}_{0}} . \qquad ( 32 )$$

Here ρ_{Li} is the ion Larmor radius and Mao is the ratio of v_{E×B} and the ion thermal velocity, evaluated at r₀. If B∝r⁻², then ρ_{Li}∝r². Moreover, if at a given z the plasma occupies a thin range of radii,

$$ψ ( r + δ r , z ) - ψ ( r , z ) = {\int }_{0}^{r + δ r} {r}^{′} {B}_{z} {dr}^{′} - {\int }_{0}^{r} {r}^{′} {B}_{z} dr \qquad ( 33 )$$

$$= r {B}_{z} ( r ) δ r + 𝒪 ( \frac{δ {r}^{2}}{{r}^{2}} ) , \qquad ( 34 )$$

so for a thin annular geometry we should roughly expect L_{⊥}∝r. Then ρ_{Li}/L_{⊥}∝r. Using this,

$$\frac{∇ {ϕ}_{\vert \vert}}{∇ {ϕ}_{⊥}} = \frac{1}{2} ( \frac{Z {T}_{e}}{Z {T}_{e} + {T}_{i}} ) {Ma}_{0} {( \frac{{ρ}_{L i}}{{L}_{⊥}} )}_{{r}_{0}} \frac{{r}_{0}^{2} - {r}^{2}}{{r}_{0}^{2}} . \qquad ( 35 )$$

In order for a configuration to have good cross-field particle confinement times, the width of the plasma likely needs to span several Larmor radii at least. Eq. (35) suggests that this constraint can be satisfied only when the Mach number is relatively large.

A related constraint suggests that fully freestanding rotation would require not only a large Mach number, but a very large parallel voltage drop. If Ma is the ratio of v_{E×B} and the ion thermal velocity at r, then using the definition of L_{⊥} from the beginning of this section,

$$Ma = \frac{Ze Δ {ϕ}_{⊥}}{{T}_{i}} \frac{{ρ}_{L i}}{{L}_{⊥}} . \qquad ( 36 )$$

That is, the Mach number is approximately the perpendicular drop in electrostatic potential energy (compared with the ion temperature) over the ion Larmor radius. For a configuration with supersonic rotation and a reasonable number of Larmor radii in width, the perpendicular drop in electrostatic potential energy must be large compared with Tᵢ. This means that whenever ∇ϕ_{∥}˜∇ϕ_{⊥}, the parallel drop must also be large compared with Tᵢ.

In the existing literature on rotating plasmas, it is common to assume that the parallel variation in ϕ is ordered to be very small compared with the cross-field variation. One way of understanding the challenges described in this section is that closing the isopotential surfaces requires finding a way to break that ordering. In particular, note that ∇ϕ_{∥}˜∇ϕ_{⊥} tends to require very fast (often supersonic) diamagnetic flows, since the pressure forces cannot be ordered small compared with eE.

Nonetheless, in principle we can conclude that it is possible to maintain very high voltage drops across a plasma while incurring little dissipation. However, it is worthwhile to keep in mind, it would mean for the particles to be Gibbs-distributed along field lines if the potential drops were very large. A megavolt-scale potential drop across a plasma with a temperature on the scale of keV would require many e-foldings of density dropoff along each field line, and would lead to equilibria that require densities low enough to be challenging to realize in a laboratory.

### Example 1A Solution

Low-dissipation solutions of the kind described by Eq. (28) are not always straightforward to find. However, it is possible to find solutions to Eq. (28) that are valid for any choice of (cylindrically symmetric) field. For example,

$$ϕ ( χ , ψ ) = {( ϕ {( χ , {ψ}_{i} )}^{1 / 2} \pm \frac{1}{2} \sqrt{\frac{2 e}{{m}_{i}} \frac{Z {T}_{e} + {T}_{i}}{{T}_{i}}} {\int }_{{ψ}_{i}}^{ψ} \frac{d {ψ}^{′}}{r ( χ , {ψ}^{′} )} )}^{2} \qquad ( 37 )$$

solves Eq. (28) for any choice of nonnegative ϕ(×, ψᵢ). The magnetic field geometry appears through the coordinate transformation r(χ, ψ) (the radial coordinate expressed in terms of χ and ψ). Depending on the prefactor of the integral in Eq. (37), this family of solutions can lead to closed isopotential surfaces.

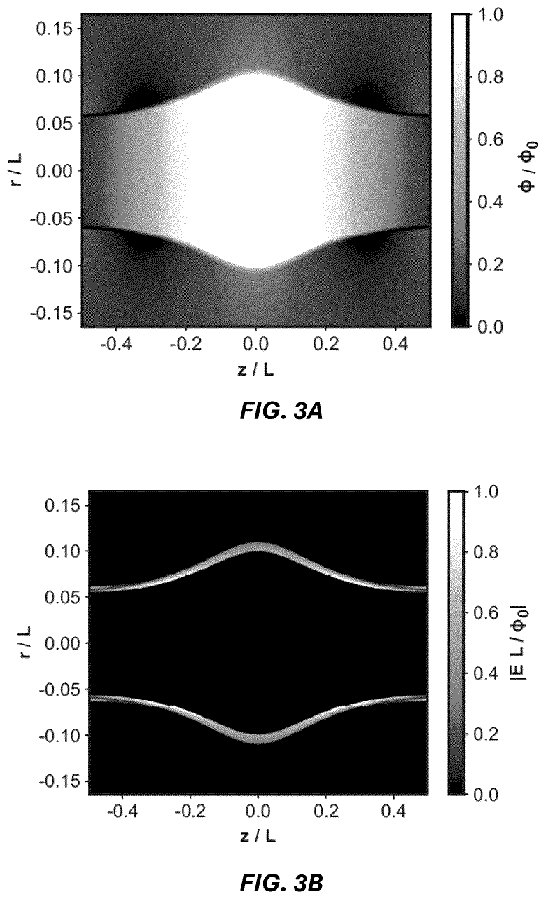

A solution of this form is plotted in FIGS. 3A-B. Plotting solutions of this kind requires choosing which region will be occupied by plasma, with ϕ governed by Eq. (37), and which will instead be the vacuum solution determined by Laplace's equation. The constraints described here suggest limiting the plasma to appear only within some relatively thin range of flux surfaces. FIGS. 3A-B show an example solution from Eq. (37) with total (E×B and diamagnetic) flux surface isorotation and vanishing parallel current. FIG. 3A shows the potential ϕ and FIG. 3B shows |E|. This particular solution has the nice property that there are regions near the edge with very small electric fields, despite supporting (potentially large) fields in the interior. For the particular example plotted in FIGS. 3A-B, the plasma is restricted to occupy the region in which ψᵢ<ψ<ψ_{f}, where ψᵢ=0.00237B₀L² and ψ_{f}=0.00284B₀L² (corresponding to 0.1<r/L<0.11 at the midplane). This example uses ϕ(χ, ψᵢ)=ϕ₀e^{-L}^{²}^{χ}^{²}^{/B}^{₀}^{²}. It uses the negative branch of Eq. (36) and (eB₀²L²/2mᵢϕ₀)[(ZTe+Tᵢ)/Tᵢ] set to 10⁴. The underlying field is described by Eqs. (14) and (17).

These choices are arbitrary, so it is important to understand FIGS. 3A-B are an illustrative example rather than a definitive embodiment of this class of solutions. It does have the interesting property that there is a region near the ends of the plasma where the electric field becomes small. This suggests that an endplate or plasma-facing component shaped in the right way could experience a much smaller electric field than the field present in the plasma interior.

To drive an equilibrium like the one described above, the basic field and device geometry would not be so different from a conventional rotating-mirror experiment; with good enough cross-field confinement, one could imagine initializing an annular density profile in a linear device. The more difficult problem is likely how to drive the necessary electric field structure.

Two promising techniques for driving and controlling electric fields in the interior of a plasma are RF current drive and neutral beams. In either case, the idea is to impose some torque on the interior of the plasma; there is a one-to-one mapping between the local torque and the cross-field current drive. The ability of these techniques to produce a particular potential profile relies on their ability to deposit angular momentum precisely in the desired locations in the plasma. In the case of RF waves, for example, this depends on finding a wave with a spatial damping profile that will put the angular momentum where it needs to go in order to produce the desired ϕ(x, y).

Note that even for a particular choice of ϕ(χ, ψ), the wave and neutral beam deposition profiled would depend on additional free parameters such as the plasma density. For any given parameter regime and choice of equilibrium, attaining a particular equilibrium will require an array of RF antennas, neutral beam launchers, or some combination of the two.

Virtually all plasma confinement devices are subject to instabilities of one kind or another. Now, it is important to keep in mind that the equilibria proposed here constitutes a broad class of configurations, and the instabilities that will be most important for one equilibrium in that class may be different from those that are most important for another. Still, it is worth pointing out which instabilities are likely to be of greatest concern.

These equilibria fall within the broader category of rotating-mirror configurations, so many of the instabilities to consider are the same ones that challenge all devices in this class. These include magnetohydrodynamic (MHD) flute modes as well as mirror mircoinstabilities (particularly loss-cone modes).

Rotating mirrors generally have stability advantages over their non-rotating counterparts for two reasons. One of these has to do with sheared rotation—that is, not the shear along flux surfaces that the equilibria described herein avoids by construction, but the shear between flux surfaces. There is evidence that shear flow can suppress MHD modes in rotating mirrors, and more generally that sufficient shear can suppress turbulent transport. The second reason for their improved stability is that centrifugal mirror traps tend to have more isotropic velocity-space distributions than do conventional mirrors, with sonic or supersonic rotation sufficient to suppress many of the major loss-cone instabilities. None of this is to say that all equilibria satisfying Eq. (28) will necessarily avoid these instabilities. Rather, it suggests that the subset of these solutions with (1) sonic or supersonic rotation and (2) sufficient shear between flux surfaces may be able to avoid them. Moreover, there are situations in which rotation can make stabilization more difficult. For example, even though shear flow tends to stabilize flute modes, centrifugal forces tend to destabilize them, so the net effect of the rotating flow depends on the balance between these two effects.

The special properties of these particular rotating mirror equilibria may also make some instabilities more challenging. If the plasma occupies a thin annular volume, then solutions with higher peak densities must also have large density gradients. This is a source of free energy that can drive modes like the drive wave instabilities. There is a large literature on these modes and a variety of strategies to mitigate them, including cross-field shear and geometric strategies.

### DISCUSSION

The conventional picture of an open-field-line E×B rotating plasma requires that each flux surface also be a surface of (approximately) constant voltage. This comes with certain constraints. Indeed, it is difficult to imagine operating such a device beyond some maximal voltage drop; even though the plasma itself can tolerate large fields without problem, the field lines in open configurations intersect with the solid material of the device, and material components cannot survive fields beyond some threshold. Van de Graaff-type devices can sustain voltages in the tens of megavolts; it is very difficult to prevent material breakdown beyond this level (fully ionized plasma, of course, does not have this difficulty). If flux surfaces are surfaces of constant potential, then high voltages across the interior of the plasma necessarily result in high voltages across the material components, and this limits the interior voltage drop.

Limitations on the achievable electric fields are important in a variety of applications. In centrifugal traps, any limitation on the electric field can be understood as a limit on the maximum plasma temperature. To see this, note that the limit on the temperature that can be contained is set by the centrifugal potential, which is determined by the rotation velocity. This, in turn, depends on the electric and magnetic fields. Some advantage can be had by reducing the magnetic field strength (since the E×B velocity goes like E/B), but perpendicular particle confinement requires that the field not be reduced too much.

There are some applications for which open E×B configurations are feasible only if the voltage drops in the interior of the plasma can be very high. For example, thermonuclear devices burning aneutronic fuels are likely to require very high temperatures. Limitations on the achievable electric fields could determine whether or not centrifugal traps are viable for such applications. The present disclosure considers what might be required in order to relax these limitations.

First, it is important to avoid shear of the angular velocity along flux surfaces (that is, to maintain isorotation). It is well known that isorotation of the E×B rotation frequency follows any time the flux surfaces are isopotentials, but it is shown here that the general conditions for isorotation are much less strict than that.

Second, it is important to avoid excessive Ohmic dissipation for parallel electric fields. Some plasmas have higher parallel conductivities than others, but especially for hot plasmas, the conductivity (and the associated dissipation) can be very high. Fortunately, in a rotating plasma, the parallel currents are not proportional to the parallel fields. If the parallel fields are close to the “ambipolar” fields, the Joule heating vanishes. The ambipolar fields have the nice property that they also produce isorotation of the combined E×B and diamagnetic flows.

Eliminating these sources of dissipation would not result in a perfectly dissipationless system, even if all instabilities can be suppressed. Cross-field transport—at least at the classical level-would still lead to some losses (as is the case in any magnetic trap), as would cross-field viscosity. However, these effects are suppressed at high magnetic fields, so the elimination of these sources could lead to a configuration that is at least as long-lived as the timescale of Braginskii's cross-field viscosity, which is typically many orders of magnitude longer than the parallel Ohmic dissipation time.

In many cases, the parallel ambipolar fields are small compared with the perpendicular fields driving the rotation. In order for a configuration to have a large voltage drop in the plasma interior and a small voltage drop at the edges of the device, the parallel and perpendicular voltage drops must be comparable. It is shown here that this is challenging, but possible. It requires supersonic rotation, and it requires a configuration for which the perpendicular length scale is small compared with the total radius (e.g., a relatively thin annulus of plasma in a larger cylindrical device). In principle, this opens up the possibility of a much wider design space for open-field-line rotating devices than has previously been considered. Note that these solutions not only do not require end-electrode biasing, but that they could not be produced by end-electrodes alone. That is, actually setting up fields of this kind is likely to require electrodeless techniques for driving voltage drops, whether that be wave-driven, neutral beams, or something else.

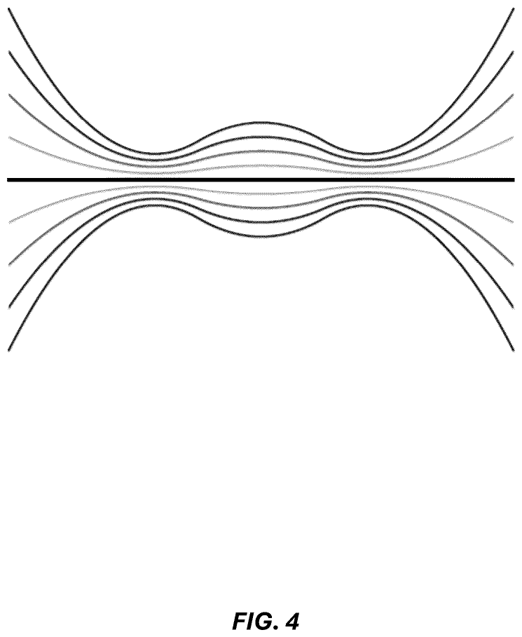

Note that the strategy discussed here results in large rotation in a simple mirror geometry; there remains the opportunity to sequence multiple such rotating mirrors in the same way that has been approached for simple non-rotating mirrors. Also note that the strategy described here is not the only possible way to reduce the fields across the material boundary of a plasma device. It is also possible to reduce these fields geometrically. If the potential is constant along every field line, and if every field line impinges somewhere on the material components of the device, then the total voltage drop between the highest the lowest point are fixed. However, the field can be reduced by arranging for the field lines to expand over a larger region before they impinge on the surface, so that the local fields are reduced (not entirely unlike a diverter). This strategy is shown in FIG. 4, which shows an alternative strategy for reducing the electric field across material components: to construct a region outside of the main mirror cell with expanding magnetic fields, so that the physical distance between field lines impinging on the outer vessel boundary is larger. If field lines are isopotentials, then this reduces the resulting fields at the boundaries by a factor that scales with the field-line spacing.

However, this strategy has clear limitations; in a cylindrically symmetric system, doubling the radius of the outer vessel reduced the fields by a factor of two. Similarly, some advantage can be gained by manipulating the angle of incidence of the magnetic field on the plasma-facing components, but this can only be pushed so far. Very large field reductions would require correspondingly large geometric expansions and may not always be a practical alternative to the solution discussed here.

### Vacuum Solutions for the Potential

If the plasma occupies some region ψᵢ≤ψ≤ψ_{f}, and we specify ϕ within this region, one may still wish to compute the isopotential contours for ψ<ψᵢ and ψ>ψ_{f}. If there is no free charge in the unoccupied regions, ϕ must satisfy Laplace's equation in these areas:

$${∇}^{2} ϕ = 0 . \qquad ( 38 )$$

Assuming cylindrical symmetry, this is

$$\frac{1}{r} \frac{\partial }{\partial r} ( r \frac{\partial ϕ}{\partial r} ) + \frac{{\partial }^{2} ϕ}{\partial {z}^{2}} = 0. \qquad ( 39 )$$

For solutions that are periodic in z, with boundary conditions such that ϕ vanishes at z=±L/2, ϕ(ψ<ψᵢ) can be written as the series solution

$$ϕ = {\sum }_{n = 0}^{∞} {A}_{n} cos ( \frac{2 π n z}{L} ) {I}_{0} ( \frac{2 π n r}{L} ) \qquad ( 40 )$$

and ϕ(ψ>ψ_{f}) can be written as

$$ϕ = {C}_{0} + {\sum }_{n = 1}^{∞} {C}_{n} cos ( \frac{2 π n z}{L} ) {K}_{0} ( \frac{2 π n r}{L} ) . \qquad ( 41 )$$

Here I₀ is a modified Bessel function of the first kind, K₀ is a modified Bessel function of the second kind, and the Aₙ and Cₙ are scalar coefficients. This choice of eigenfunctions imposes the constraint that ϕ must be well behaved near r=0 for the inner solution and must converge to some constant value when r→∞ for the outer solution. In the context of this problem Aₙ and Cₙ are chosen to match the boundary curves ϕ(χ,ψᵢ) and ϕ(χ, ψ_{f}), respectively. For the particular case shown in FIGS. 3A-B, the first ten terms each of the Aₙ and Cₙ are used to fit the boundary.

### On Twisting Fields

One may sometimes consider system in which the E×B flow is axially sheared; that is, if v_{E×B}=rΩ_{E}\hat{θ}, ∂Ω_{E}/∂χ≠0. If E=−∇ϕ, this can result if ∂ϕ/∂χ=0.

Our intuition from ideal MHD is that this ought to lead the field lines to twist up. The ideal MHD induction equation states that

$$\frac{\partial B}{\partial t} = ∇ \times ( v \times B ) , \qquad ( 42 )$$

$$so that$$

$$\frac{\partial B}{\partial t} = ∇ \times [ {r}^{2} {Ω}_{E} ∇ θ \times B ] \qquad ( 43 )$$

$$= ∇ \times ( {Ω}_{E} ∇ ψ ) \qquad ( 44 )$$

$$= ∇ {Ω}_{E} \times ∇ ψ . \qquad ( 45 )$$

This would imply that

$$\frac{\partial {B}_{θ}}{\partial t} = 0 iff . \frac{\partial {Ω}_{E}}{\partial χ} = 0. \qquad ( 46 )$$

In other words, the ideal MHD induction equation appears to suggest that axial shear of Ω_{E} twists up the field lines.

However, this is not the case. To see why, note that this argument (and all of the intuition behind it) relies on mixing the ideal MHD induction equation with an E×B drift that is not consistent with ideal MHD. In ideal MHD,

$$E = - v \times B ; \qquad ( 47 )$$

the theory does not permit any component of E in the direction of B. (In rotating mirrors, one gets a parallel component of ϕ by including electron-pressure correction in an extended-MHD Ohm's law, but this is not essential to the argument).

Consider instead the original form of Faraday's equation:

$$\frac{\partial B}{\partial t} = - ∇ \times E . \qquad ( 48 )$$

If E=−∇ϕ, we do not get twisting of the field lines, no matter what kind of dependences ϕ might have. So, in a rotating mirror, it is incorrect to conclude that nonisorotation must necessarily lead to B_{θ}.

If one derives the form of the steady-state ϕ that results from, e.g., electron pressure, one finds that the corresponding correction term to the MHD induction equation always cancels any field-line twisting—as it is known that it must, from Faraday's equation.

### Example 2

Consider a fully ionized column of plasma immersed in an axially directed magnetic field. It is desired to produce a radial DC electric field (perpendicular to the magnetic field) so that the plasma column will undergo steady state rotation. The larger the electric field, in other words the larger the voltage that can be imposed across the plasma, the faster the rotation for a given magnetic field strength. The plasma column is presumed to be confined in the axial direction either through mirror forces, whereby the axial field is strongest at the axial ends of the plasma, or centrifugally, whereby the centrifugal potential is the strongest at the axial ends of the plasma for any given magnetic field line. The issue in an open-field-line configuration is that the axial magnetic fields will necessarily eventually encounter a wall, possible bringing plasma into contact with the walls or producing electric fields in the vicinity of the walls too large for the wall to withstand. In either case, significant power could be dissipated in the wall, eroding the wall and bringing impurities into the plasma.

Current techniques of exerting large voltages across magnetized plasma involve placing concentric ring electrodes at the axial boundaries of the plasma and defining electric potentials across the rings. Since each field line in plasma is thought to be largely an equipotential line if the plasma is hot enough, the voltages defined at the wall would then be felt within the plasma. However, there are two problems with this method. One, to define the equipotential from the electrode to the plasma, hot plasma must contact the electrode, leading to erosion, dissipation, and other issues. Two, there is a limit to how large a potential drop can be produced outside the plasma; the maximum voltages possible tend to be in the megavolt range or below, after which material electrodes encounter arcing.

Alternatively, here, voltages may be generated across the magnetized plasma through wave-particle interactions. The suggestion is that waves can deconfine particles of one sign of charge, leading to a voltage drop across the plasma. In the case of strict alpha channeling, deconfined ions are energetic alpha particles, which also favorably give up energy to the wave upon exiting the plasma, thus supporting the potential. This mechanism may be utilized for cross-field voltage drops below some size. However, if the voltage drop is very large within the plasma, and that voltage drop is then defined along field lines that encounter a wall, then the issue becomes how to avoid large dissipation on the walls, which can produce further problems such as sputtering, melting, erosion and the importing of impurities into the plasma.

Magnetic field lines can be expanded upon leaving the plasma before encountering a wall. In other words, magnetic fields may assume a diverging nozzle geometry. This configuration has several advantages. One, the same voltage drop at the wall produces less of an electric field at the wall, thereby limiting the wall damage. Two, the centrifugal forces all point towards the wall hence, any impurities eroded from the wall cannot easily enter the plasma. Three, the plasma may be cooled upon expansion, thereby becoming more resistive and making the electrical contact with the wall poorer, meaning that there will be a voltage drop along the field lines that lessens the voltage drop across the field lines in the vicinity of the wall.

Cold plasma or gas can be introduced between the wall and the hot fully ionized and magnetized plasma. This will increase the resistivity along the field lines inducing a voltage drop in cold plasma. This in turn has the beneficial effect of lowering the voltage seen at the wall, thereby limiting the dissipation at the wall, where the heat can cause erosion. Dissipation in the plasma is less damaging.

In addition to increasing the resistivity, the introduction of cold plasma or the introduction of diverging field lines, or a combination of the two, can lead to the preferential transport of either positively charged ions or negatively charged electrons. This preferential transport introduces a voltage drop along the field lines that, similar to resistivity, lessens the voltage drop at the walls. However, in some cases, the voltage drop along the field lines might be advantageously used for direct energy conversion, rather than in situ conversion to heat.

Additionally, whatever voltage is carried to the walls can be handled better through the shaping of the walls or the local fields. In this respect, one might bunch field lines into conducting wall regions which act as electrodes separated by insulators. Alternatively, or in conjunction, the wall can be segregated so that field lines first encounter either the first set of conducting regions or the second set of conducting regions, thereby increasing the distances between regions held at different voltages, which also lessens the local electric fields.

Additional strategies may include “isolating” a very large radial voltage drop in an interior of plasma, so the electric field at the device wall is much smaller than the field in the plasma interior. Ordinarily, this would be prohibited for multiple reasons: (1) the high conductivity along field lines would immediately equalize the voltage along the magnetic field, and (2) varying electric fields would set up flow shear along the field lines. Both (1) and (2) would typically lead to untenable levels of dissipation inside the plasma. However, both problems can be avoided by carefully setting the field strength and shape so as to use centrifugal forces to modify the plasma conductivity in the direction parallel to the magnetic field. Doing so, while also respecting requirements like the Brillouin limit requires a characteristic field geometry in which the plasma occupies a relatively thin-annular region in an otherwise mirror-like device.

These approaches may be used to control the voltage along and across field lines, thereby to allow for large voltage drops in a fully ionized magnetized and rotating plasma column, while limiting the damage and dissipation at the point where the magnetic field encounter material walls.

What is claimed:

1. A method for producing a voltage across a magnetized plasma, comprising:
generating, within a plasma device having at least one outer boundary that defines walls, at least one magnetic field including an axially directed magnetic field in an open field line configuration, wherein the axially directed magnetic field confines a plasma in a direction perpendicular to the magnetic field; and
generating at least one electric field within the plasma device.

2. The method of claim 1, wherein the at least one electric field have a component parallel to magnetic field lines such that the at least one electric field is larger in an interior region of the plasma and substantially reduced near the walls of the plasma device.

3. The method of claim 1, further comprising reducing electric field strength near the walls by increasing resistivity of the plasma.

4. The method of claim 3, further comprising introducing a cold plasma between the walls and the plasma.

5. The method of claim 4, further comprising introducing radiating impurities into the cold plasma.

6. The method of claim 1, further comprising modifying a geometry of magnetic field lines such that the magnetic field lines spread before contacting the walls.

7. The method of claim 1, further comprising modifying an angle of contact between magnetic field lines and the walls.

8. The method of claim 1, wherein the at least one magnetic field is configured to have a plurality of magnetic field lines shaped into conducting wall regions which act as electrodes separated by insulators.

9. The method of claim 1, wherein the at least one electric field and at least one magnetic field are configured to mitigate natural dissipation of the electric fields.

10. The method of claim 1, further comprising isolating a radial voltage drop in an interior of the plasma so an electric field at the wall is smaller than an electric field in the interior of the plasma by setting field strength and shape of the at least one magnetic field so as to use centrifugal forces to modify plasma currents in a direction parallel to the magnetic field.

11. The method of claim 1, further comprising generating at least a part of a voltage drop using wave-particle interactions.

12. The method of claim 1, further comprising generating at least a part of a voltage drop using torque from neutral beams.

13. The method of claim 1, wherein the at least one magnetic field comprises a diverging nozzle geometry.

14. A system, comprising:
a magnetic field source configured to generate at least one magnetic field including an axially directed magnetic field in an open field line configuration, wherein the axial-directed magnetic field is configured to confine a plasma in a direction perpendicular to the magnetic field; and
an electric field source configured to generate steady-state electric fields parallel to magnetic field lines produced by the magnetic field source such that the electric fields are larger in an interior region of the plasma and substantially reduced in boundary regions of the plasma.
